(19) United States
(12) Patent Application Publication
(10) Pub. No.: US 2025/0075845 A1
(43) Pub. Date: Mar. 6, 2025

(54) Quick-Release Tripod Head

(71) Applicant: Zhongshan Jingge Electronic Technology Co., Ltd., Zhongshan City (CN)

(72) Inventors: Lichun Huang, Hunan (CN); Long Bai, Deyang City (CN); Yongyue Liao, Yangchun City (CN)

(21) Appl. No.: 18/412,750

(22) Filed: Jan. 15, 2024

(30) Foreign Application Priority Data
Aug. 31, 2023 (CN) 202322364565.5

(51) Int. Cl. F16M 11/04

(52) U.S. Cl. CPC F16M 11/041

(57) ABSTRACT

The present invention discloses a quick-release tripod head comprising: a quick-release plate having first and second pivot axles on the left and right sides, respectively, for attaching photography equipment; a base having a first snap-fit hinged structure on the left side and a second snap-fit hinged structure on the right side. The first and second snap-fit hinged structures can snap-fit to the pivot axles when locked, thereby securing the quick-release plate to the base; or the quick-release plate can pivot laterally about either pivot axle to form a predetermined angle with the base when one snap-fitting structure is unlocked and the other is locked. This structure allows the quick-release plate to be quickly installed or removed using the pivot axles, and allows the plate to flip up laterally relative to the base, thereby simplifying the structure and reducing the thickness of the head, which facilitates a more compact shape.

### FIELD OF INVENTION

The present invention relates to the field of photography equipment, in particular a quick-release tripod head.

### BACKGROUND OF THE INVENTION

As the standard of living increases, more and more people are embracing photography. Users often use heads to support their photography equipment for angle adjustment and accessory installation. Since photography requires both horizontal and vertical framing, i.e., switching the camera between landscape and portrait modes, flip heads have been developed. These flip heads facilitate the camera to be flipped laterally, altering the orientation from horizontal to vertical. Typically, cameras are connected to the head via a dedicated quick-release plate, which requires a connection seat that is integrated into the head via a flip-up mechanism, and this seat must include a connection structure compatible with the quick-release plate, making the head not only structurally complex but also tall, which is counterproductive to compact head designs. Hence, there is a significant need for a quick-release tripod head to address these issues.

### SUMMARY OF THE INVENTION

The present invention aims at solving at least one of the technical problems existing in the prior art. To this end, a quick-release tripod head is proposed.

An embodiment of the present invention that addresses the technical problem adopts the following technical solution: a quick-release tripod head, comprising:

A quick-release plate, having a first pivot axle on the left side and a second pivot axle on the right side, to which photography equipment can be attached; and
a base, having a first snap-fit hinged structure on the left side and a second snap-fit hinged structure on the right side.

Wherein, the first and second snap-fit hinged structures can snap-fit to the first and second pivot axles, respectively, when in a locked state, thereby securing the quick-release plate to the base. Alternatively, the quick-release plate can pivot laterally about the first or second pivot axle as a center of rotation to form a predetermined angle with the base when one of the snap-fit hinged structures is in an unlocked state and the other is in a locked state.

Preferably, the first snap-fit hinged structure comprises:

A rotation slot, provided on the base;
a movable cavity, provided on the base; and
a snap-fit seat, movably provided within the movable cavity and having a snap-fitting part positioned beside the rotation slot.

Wherein, the snap-fit seat can drive the snap-fitting part to snap-fit to the first pivot axle when the second snap-fit hinged structure is in a locked state, securing the quick-release plate to the base. Alternatively, the snap-fit seat can drive the snap-fitting part to disengage from the first pivot axle, allowing the quick-release plate to flip up laterally about the second pivot axle.

Preferably, the quick-release tripod head also comprises:

A movable slot, connected to the rotation slot and the movable cavity; and
a locking pin, comprising a linkage provided in the movable slot and a stop flange provided in the movable cavity.

Wherein, the snap-fit seat is equipped with a first limit groove and a second limit groove that are staggered in height and in lateral direction. The first pivot axle can press against the linkage or disengage from the linkage when extending into the rotation slot, causing the stop flange to switch between the first and second limit grooves, thus toggling the snap-fit seat between the locked and unlocked states.

Preferably, the quick-release tripod head further comprises a first reset member abutting the stop flange and the base, and a second reset member abutting the snap-fit seat and the base, respectively. The first reset member is arranged in a height direction, while the second reset member is arranged in a left-right direction.

Preferably, the first and/or second reset member is a spring.

Preferably, a pressing arc surface is provided on the side of the snap-fitting part near the first pivot axle.

Preferably, the front and rear sides of the quick-release plate are connected to the base by a limiting structure which limits the movement of the quick-release plate in the front-back direction relative to the base.

Preferably, the limiting structure comprises a first limiting slope on the front side of the base inclined outwardly, a second limiting slope on the rear side of the base inclined outwardly, a third limiting slope on the front side of the quick-release plate inclined outwardly, and a fourth limiting slope on the rear side of the quick-release plate inclined outwardly. The third limiting slope may abut against the first limiting slope when the quick-release plate is mounted on the base, and the fourth limiting slope may similarly abut against the second limiting slope.

Preferably, the front and rear sides of the quick-release plate are equipped with quick-release interfaces.

Preferably, the quick-release interfaces are designed as Arca-type or Manfrotto-type sliders.

The advantageous effects of the present invention are as follows: the quick-release tripod head comprising the quick-release plate having the first and second pivot axle on the left and right sides, where photography equipment can be attached; the base having the first and second snap-fit hinged structures on the respective sides thereof; both of the snap-fit hinged structures, when in the locked state, can snap-fit to the first and second pivot axles to secure the quick-release plate to the base; or allow the quick-release plate to flip up laterally about the first or second pivot axle as the center of rotation, forming a predetermined angle with the base when one of the snap-fit hinged structures is in the unlocked state and the other is in the locked state. The design of the first and second pivot axles enables the quick-release plate to be quickly mounted on or removed from the head, and the plate to pivot laterally relative to the base about the pivot axles. The design is not only simpler, but also reduces the thickness of the head, facilitating a more compact shape.

### BRIEF DESCRIPTION OF THE DRAWINGS

The above and/or additional aspects and advantages of the present invention will be clear and readily understood from the description of the embodiments in conjunction with the accompanying drawings, wherein:

FIG. 1 is a schematic view of the first structure of the quick-release tripod head;

FIG. 2 is a schematic view of the second structure of the quick-release tripod head;

FIG. 3 is an exploded view of the quick-release tripod head;

FIG. 4 is a sectional view of the quick-release tripod head;

FIG. 5 is a partially enlarged view of area A in FIG. 4; and

FIG. 6 is a schematic view of the structure of the snap-fit seat.

### DETAILED DESCRIPTION OF THE PREFERRED EMBODIMENTS

In this section, specific embodiments of the present invention will be described in detail. The preferred embodiments of the present invention are shown in the accompanying drawings, which serve to supplement the textual description of the specification with drawings to provide a visual and illustrative understanding of each technical feature and the overall technical scheme of the present invention. However, it should not be construed as a limitation on the scope of protection of the present invention.

As used in the specification of the present invention, the term “multiple” means two or more. Terms such as “greater than”, “less than”, and “exceed” should be understood to exclude the number itself, while terms such as “above”, “below”, and “within” should be understood to include the number itself. The terms “first”, “second”, etc., are used only to distinguish technical features and should not be construed as indicating or implying relative importance or as implying the number or order of technical features referred to.

In the description of the present invention, it should be understood that terms relating to orientation, such as “up”, “down”, “front”, “back”, “left”, “right”, etc., are based on the orientation or positional relationships shown in the drawings. These are only for convenience in describing the present invention and simplifying the description, and do not indicate or imply that the device or element referred to must have a particular orientation, be constructed and operated in a particular orientation, and should therefore not be considered as a limitation of the present invention.

In the present invention, unless otherwise expressly limited, terms such as “provided”, “mounted”, and “connected” should be understood broadly. For instance, they could mean directly connected or indirectly connected through an intermediary; they could mean permanently connected or detachably connected; they could mean integrally formed; they could mean mechanically connected; they could mean internal communication or interaction between two elements. Those skilled in the relevant art will be able to determine the specific meanings of these terms in the present invention through the context of the specific technical scheme.

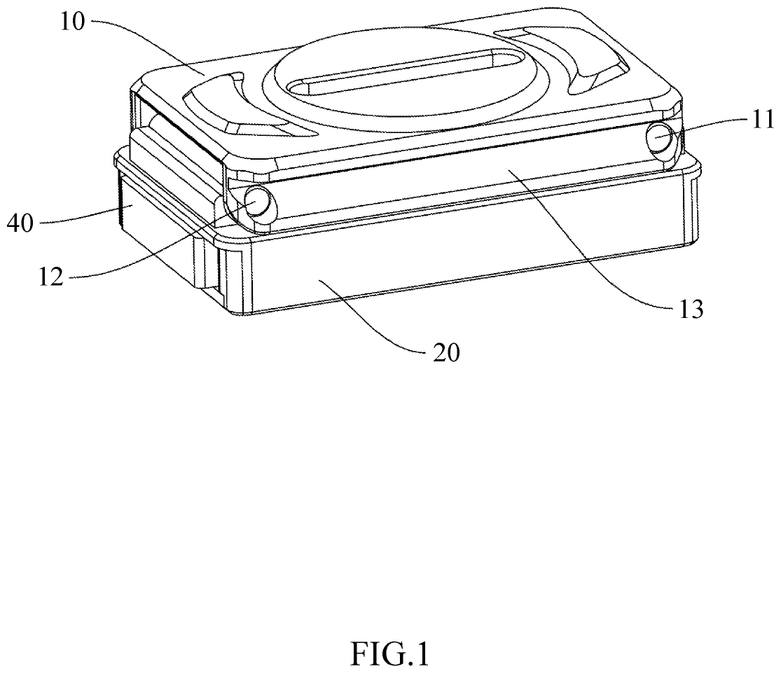

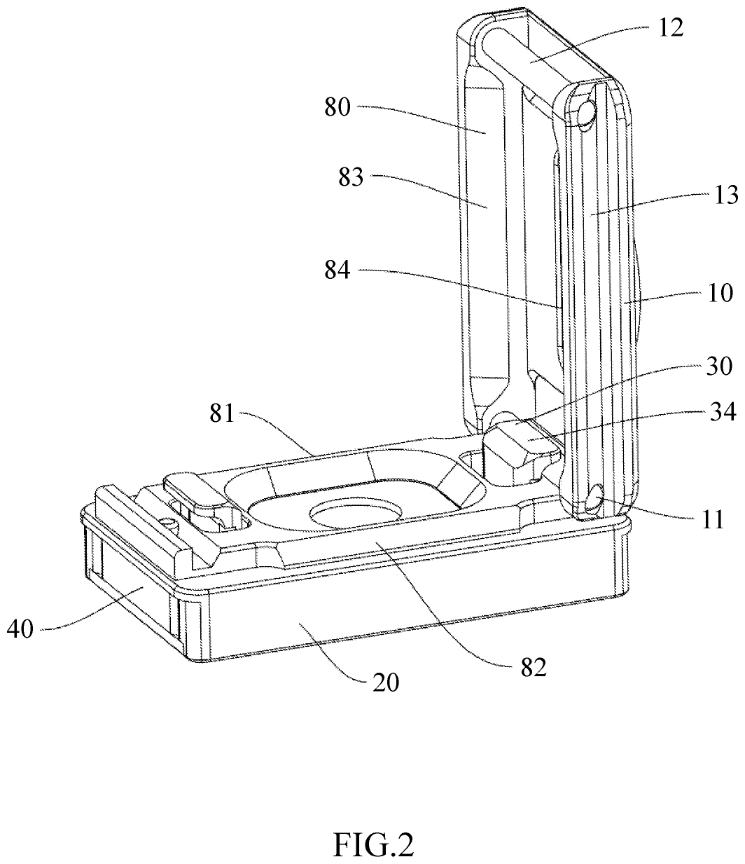

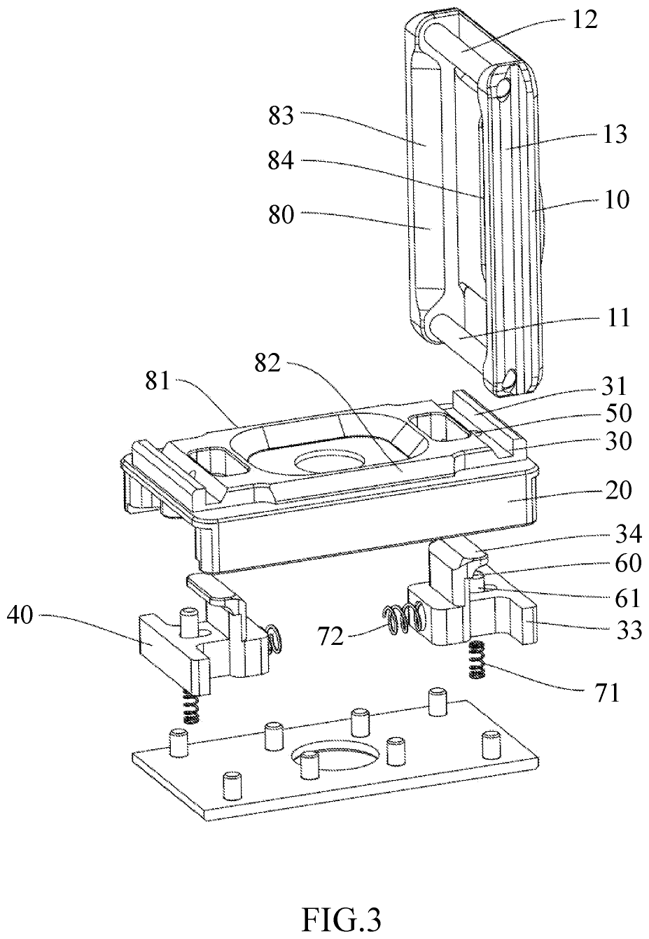

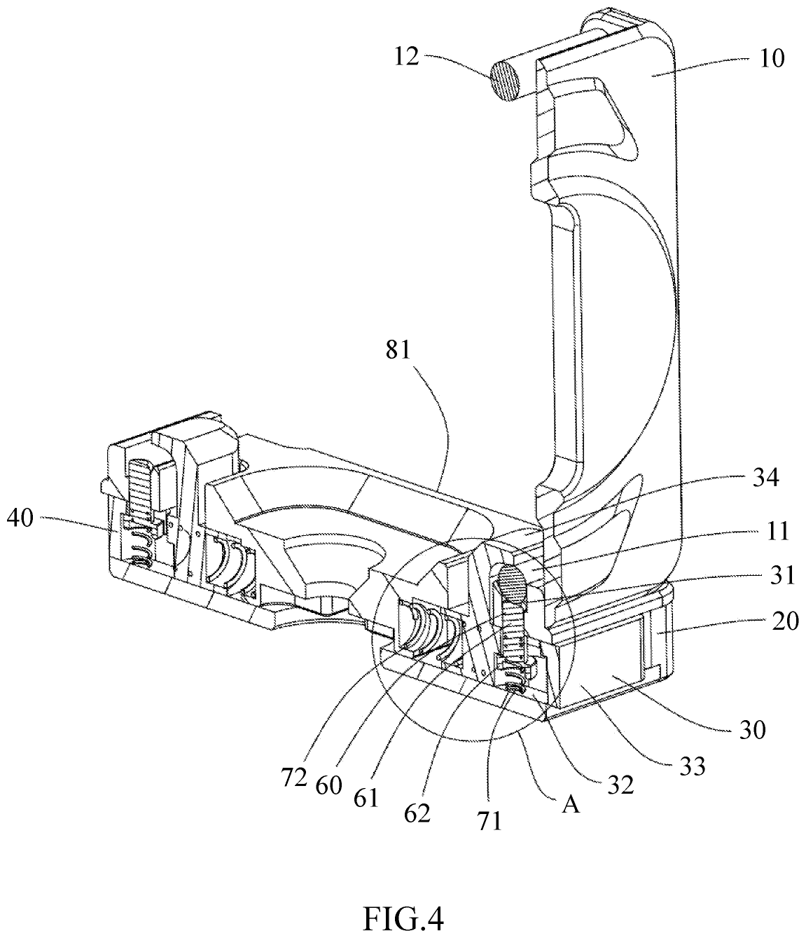

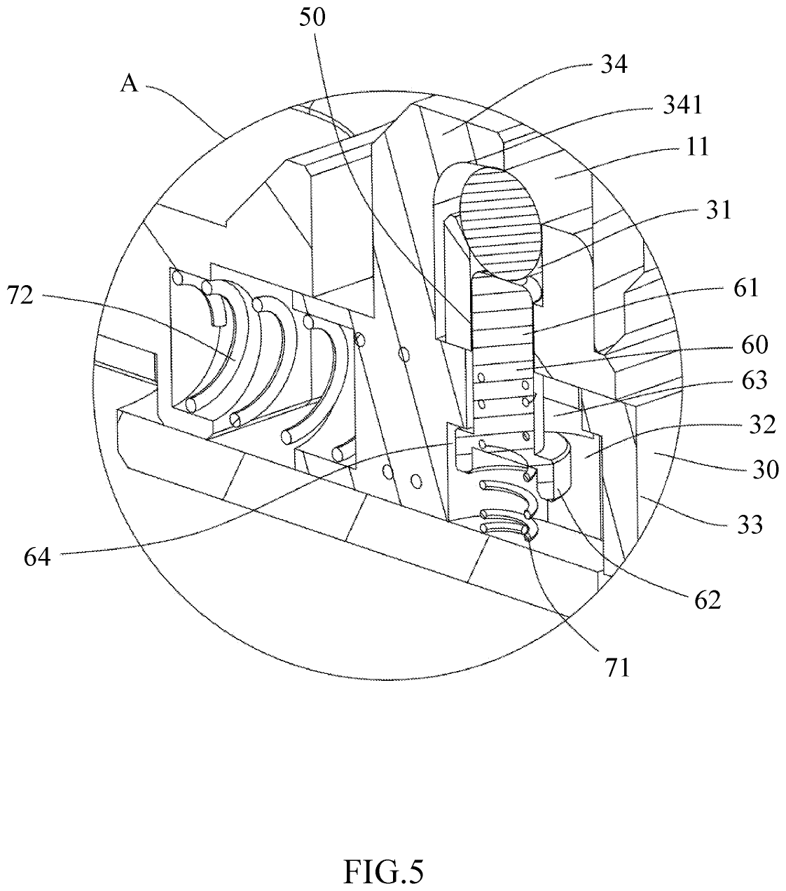

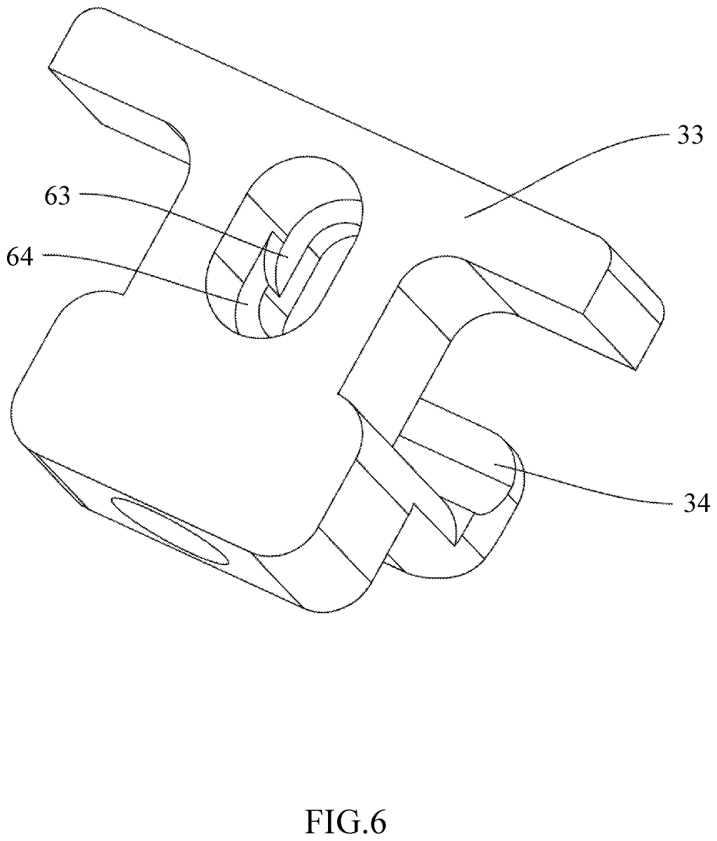

Referring to FIGS. 1 to 6, a quick-release tripod head comprises:

A quick-release plate 10, having a first pivot axle 11 and a second pivot axle 12 on the left and right sides, respectively, to which photography equipment can be attached;
a base 20, having a first snap-fit hinged structure 30 on the left side and a second snap-fit hinged structure 40 on the right side.

Wherein, the first snap-fit hinged structure 30 and the second snap-fit hinged structure 40 can snap-fit to the first pivot axle 11 and the second pivot axle 12, respectively, when in a locked state, thereby securing the quick-release plate 10 to the base 20. Alternatively, the quick-release plate 10 can pivot laterally about the first pivot axle 11 or the second pivot axle 12 as a center of rotation to form a predetermined angle with the base 20 when one of the snap-fit hinged structures is in an unlocked state and the other is in a locked state.

### In the Present Invention:

1. Referring to FIG. 1, the state of the head is shown when the photography equipment is photographed in a horizontal direction. In installation, the photography equipment is first mounted on the quick-release plate 10. Then, the first pivot axle 11 and the second pivot axle 12 on both sides of the quick-release plate 10 are inserted into snap-fitting spaces formed by the snap-fitting part 34 and the rotation slot 31 of the first snap-fit hinged structure 30 and the second snap-fit hinged structure 40, respectively. Here, the snap-fitting process of the first pivot axle 11 is illustrated as an example. A stop flange 62 is located within a first limit groove 63, and a second reset member 72 is under the compression, allowing the snap-fitting part 34 and the rotation slot 31 to form a snap-fitting space larger than the first pivot axle 11 for direct insertion and to abut against a linkage 61. During insertion, the first pivot axle 11 pushes a locking pin 60 downward along the height direction so that the stop flange 62 moves from the first limit groove 63 to a second limit groove 64 and a snap-fit seat 33 moves from right to left under the action of a first reset member 71, thereby pressing against the upper surface of the stop flange 62 to restrict the upward movement of the locking pin 60, while at the same time causing the snap-fitting part 34 to press against the first pivot axle 11, thereby reducing the snap-fitting space and securing the first pivot axle 11 within the snap-fitting space, but allowing the first pivot axle 11 to rotate. The second pivot axle 12 is secured in a similar manner, which ultimately connects the quick-release plate 10 to the base 20.

2. The process of disengaging the quick-release plate 10 from the base 20 is as follows: pushing the snap-fit seat 33 from left to right, separating the upper surface of the stop flange 62 from the snap-fit seat 33. The first reset member 71 resets and pushes the locking pin 60 upward, allowing the linkage 61 to extend into the rotation slot 31, and the stop flange 62 moves from the second limit groove 64 into the first limit groove 63. The snap-fitting part 34 then moves with the snap-fit seat 33 away from the first pivot axle 11 until the snap-fitting part 34 is disengaged from the first pivot axle 11. As a result of the snap-fitting space is enlarged so that the first pivot axle 11 can be removed from the snap-fitting space.

3. When the first snap-fit hinged structure 30 is in the locked state and the second snap-fit hinged structure 40 is in the unlocked state, the right side of the quick-release plate 10 can move relative to the base 20, i.e., the quick-release plate 10 can flip up laterally about the first pivot axle 11 as a center of rotation with a preferred pivot angle of 90°.

4. The advantage of the present invention is that: quick installation and removal of the quick-release plate 10 to and from the head is possible via the first pivot axle 11 and the second pivot axle 12. Meanwhile, the quick-release plate 10 can pivot laterally relative to the base 20 about the first pivot axle 11 or the second pivot axle 12, which not only provides a simpler structure, but also a reduced thickness of the head, which facilitates a more compact shape.

As a preferred embodiment, the first snap-fit hinged structure 30 comprises:

A rotation slot 31, provided on the base 20;
a movable cavity 32, provided on the base 20; and
a snap-fit seat 33, movably provided within the movable cavity 32 and having a snap-fitting part 34 positioned beside the rotation slot 31.

Wherein, the snap-fit seat 33 can drive the snap-fitting part 34 to snap-fit to the first pivot axle 11 when the second snap-fit hinged structure 40 is in the locked state, thereby securing the quick-release plate 10 to the base 20. Alternatively, the snap-fit seat 33 can drive the snap-fitting part 34 to disengage from the first pivot axle 11, allowing the quick-release plate 10 to flip up laterally about the second pivot axle 12.

The quick-release tripod head also comprises:

A movable slot 50, connected to the rotation slot 31 and the movable cavity 32; and
a locking pin 60, comprising the linkage 61 provided in the movable slot 50 and the stop flange 62 provided in the movable cavity 32.

Wherein, the snap-fit seat 33 is equipped with the first limit groove 63 and the second limit groove 64 that are staggered in height and in lateral direction. The first pivot axle 11 can press against the linkage 61 or disengage from the linkage 61 when extending into the rotation slot 31, causing the stop flange 62 to switch between the first limit groove 63 and the second limit groove 64, thus toggling the snap-fit seat 33 between the locked and unlocked states.

The quick-release tripod head further comprises the first reset member 71 abutting the stop flange 62 and the base 20, and the second reset member 72 abutting the snap-fit seat 33 and the base 20, respectively. The first reset member 71 is arranged in a height direction, while the second reset member 72 is arranged in a left-right direction.

Preferably, the first reset member 71 and/or the second reset member 72 is a spring.

A pressing arc surface 341 is provided on the side of the snap-fitting part 34 near the first pivot axle 11; by providing the pressing arc surface 341, the snap-fit seat 33 can stably and reliably press against the first pivot axle 11 under the action of the second reset member 72, thereby achieving a stable connection between the quick-release plate 10 and the base 20.

The front and rear sides of the quick-release plate 10 are connected to the base 20 by a limiting structure 80 which limits the movement of the quick-release plate 10 in the front-back direction relative to the base 20. As a preferred embodiment, the limiting structure 80 comprises a first limiting slope 81 on the front side of the base 20 inclined outwardly, a second limiting slope 82 on the rear side of the base 20 inclined outwardly, a third limiting slope 83 on the front side of the quick-release plate 10 inclined outwardly, and a fourth limiting slope 84 on the rear side of the quick-release plate 10 inclined outwardly. The third limiting slope 83 may abut against the first limiting slope 81 when the quick-release plate 10 is mounted on the base 20, and the fourth limiting slope 84 may similarly abut against the second limiting slope 82.

The front and rear sides of the quick-release plate 10 are equipped with quick-release interfaces 13; preferably, the quick-release interfaces 13 are designed as Arca-type or Manfrotto-type sliders, enabling the quick-release plate 10 to be used with heads equipped with the standard quick-release interfaces 13, thereby increasing the applicability of the quick-release plate 10.

Of course, the present invention is not limited to the above embodiments. Those skilled in the art may make equivalent modifications or substitutions without departing from the spirit of the present invention, and such equivalent modifications and substitutions are included within the scope defined by the claims of this application.

What is claimed is:

1. A quick-release tripod head, comprising:
a quick-release plate (10), having a first pivot axle (11) and a second pivot axle (12) on the left and right sides, respectively, to which photography equipment is attached; and
a base (20), having a first snap-fit hinged structure (30) on the left side and a second snap-fit hinged structure (40) on the right side;
wherein, the first snap-fit hinged structure (30) and the second snap-fit hinged structure (40) snap-fit to the first pivot axle (11) and the second pivot axle (12), respectively, when in a locked state, thereby securing the quick-release plate (10) to the base (20); or the quick-release plate (10) pivots laterally about the first pivot axle (11) and the second pivot axle (12) to form a predetermined angle with the base (20) when one of the snap-fit hinged structures is unlocked and the other is locked.

2. The quick-release tripod head according to claim 1, wherein the first snap-fit hinged structure (30) comprises:
a rotation slot (31), provided on the base (20);
a movable cavity (32), provided on the base (20); and
a snap-fit seat (33), movably provided within a movable cavity (32) and having a snap-fitting part (34) positioned beside the rotation slot (31);
wherein, the snap-fit seat (33) drives the snap-fitting part (34) to snap-fit to the first pivot axle (11) when the second snap-fit hinged structure (40) is in the locked state, thereby securing the quick-release plate (10) to the base (20); or the snap-fit seat (33) drives the snap-fitting part (34) to disengage from the first pivot axle (11), allowing the quick-release plate (10) to flip up laterally about the second pivot axle (12).

3. The quick-release tripod head according to claim 2, further comprising:
a movable slot (50), connected to the rotation slot (31) and the movable cavity (32); and
a locking pin (60), comprising a linkage (61) provided in the movable slot (50) and a stop flange (62) provided in the movable cavity (32);
wherein, the snap-fit seat (33) is equipped with a first limit groove (63) and a second limit groove (64) that are staggered in height and in lateral direction, and the first pivot axle (11) presses against the linkage (61) or disengages from the linkage (61) when extending into the rotation slot (31), causing the stop flange (62) to switch between the first limit groove (63) and the second limit groove (64), thus toggling the snap-fit seat (33) between the unlocked and locked states.

4. The quick-release tripod head according to claim 3, further comprising a first reset member (71) abutting the stop flange (62) and the base (20), and a second reset member (72) abutting the snap-fit seat (33) and the base (20), respectively; the first reset member (71) is arranged in a height direction, while the second reset member (72) is arranged in a left-right direction.

5. The quick-release tripod head according to claim 4, wherein the first reset member (71) and/or the second reset member (72) is a spring.

6. The quick-release tripod head according to claim 1, wherein a pressing arc surface (341) is provided on the side of the snap-fitting part (34) near the first pivot axle (11).

7. The quick-release tripod head according to claim 1, wherein the front and rear sides of the quick-release plate (10) are connected to the base (20) by a limiting structure (80) which limits the movement of the quick-release plate (10) in the front-back direction relative to the base (20).

8. The quick-release tripod head according to claim 7, wherein the limiting structure (80) comprises a first limiting slope (81) on the front side of the base (20) inclined outwardly, a second limiting slope (82) on the rear side of the base (20) inclined outwardly, a third limiting slope (83) on the front side of the quick-release plate (10) inclined outwardly, and a fourth limiting slope (84) on the rear side of the quick-release plate (10) inclined outwardly; the third limiting slope (83) abuts against the first limiting slope (81) when the quick-release plate (10) is mounted on the base (20), and the fourth limiting slope (84) similarly abuts against the second limiting slope (82).

9. The quick-release tripod head according to claim 1, wherein the front and rear sides of the quick-release plate (10) are equipped with quick-release interfaces (13).

10. The quick-release tripod head according to claim 9, wherein the quick-release interfaces (13) are designed as Arca-type or Manfrotto-type sliders.
